(19) United States
(12) Patent Application Publication
(10) Pub. No.: US 2026/0001093 A1
(43) Pub. Date: Jan. 1, 2026

(54) CAP FOR A WATER HEATER, EXTRACTION TOOL, AND METHOD OF MANUFACTURE

(71) Applicant: Bradford White Corporation, Ambler, PA (US)

(72) Inventors: Michael A. DeHoog, Hastings, MI (US); Jason Carroll, Hudsonville, MI (US); James Pleune, Baldwin, MI (US)

(73) Assignee: Bradford White Corporation, Ambler, PA (US)

(21) Appl. No.: 18/754,967

(22) Filed: Jun. 26, 2024

(51) Int. Cl. B05B 12/26; B05B 12/24; B23P 19/02; F24H 9/00

(52) U.S. Cl. CPC B05B 12/26; B05B 12/24; B23P 19/025; F24H 9/0005

(57) ABSTRACT

A cap for insertion into a spud of a water heater includes a base, a side wall extending from the base to define a cavity together with the base, and a flange coupled to the side wall and extending outward therefrom to a peripheral rim. The flange includes a first side and a second side that is opposite the first side and further than the first side from the base. At least one of the first side of the flange and the second side of the flange includes a plurality of grooves.

### FIELD OF THE DISCLOSURE

The present disclosure generally relates to water heaters and a method of manufacturing a tank for holding hot water. More specifically, the present disclosure relates to a cap that is configured to be inserted into a spud coupled to a tank of a water heater to conceal a threaded portion of the spud from an interior volume of the tank while a coating is applied to an interior surface of the tank. The present disclosure further relates to an extraction tool for extracting the cap from the spud.

### BACKGROUND OF THE DISCLOSURE

Water heater tanks often include spuds with threaded portions for engaging with corresponding fittings. Enameling or applying a coating to the interior surface of the water heater tank while the threaded portion is exposed can result in the coating undesirably covering the threaded portion of the spud.

### SUMMARY OF THE DISCLOSURE

According to a first aspect of the present disclosure, a cap for insertion into a spud of a water heater includes a base, a side wall extending from the base to define a cavity together with the base, and an annular skirt coupled to the side wall and having a peripheral rim distal from the side wall. The annular skirt is operable to elastically deform from a first position, wherein the annular skirt is not in contact with the spud and the peripheral rim is a first distance from the side wall, to a second position, wherein the annular skirt is in contact with a threaded portion of the spud and the peripheral rim is a second distance from the side wall. The annular skirt is also operable to resiliently rebound back from the second position to a third position, wherein the peripheral rim is positioned within an annular channel of the spud and the peripheral rim is a third distance from the side wall. The first and third distances are greater than the second distance.

Embodiments of the first aspect of the present disclosure can include any one or a combination of the following features:
the first distance is greater than the third distance;
the first distance is equal to the third distance;
the cap is formed of metal;
a portion of the annular skirt is arcuate, such that the arcuate portion of the annular skirt forms an annular concave depression; and
the arcuate portion of the annular skirt elastically deforms to allow the annular skirt to move from the first position to the second position.

According to a second aspect of the present disclosure, a method of manufacturing a tank for holding hot water includes the steps of concealing a threaded portion of a spud coupled to the tank from an interior volume defined by an interior surface of the tank with a cap by inserting the cap into a pass-through hollow that is defined by the spud and that extends from an outer opening that is distal from the tank to an inner opening that is proximal to the tank, applying a coating to the interior surface of the tank, and revealing the threaded portion of the spud to the interior volume by plastically deforming the cap to remove the cap from the pass-through hollow through the outer opening.

Embodiments of the second aspect of the present disclosure can include any one or a combination of the following features:
the cap is inserted into the pass-through hollow through the inner opening toward the outer opening;
the cap is inserted into the pass-through hollow through the outer opening toward the inner opening;
the step of welding the cap to the spud;
the cap elastically deforms during insertion of the cap into the pass-through hollow due to contact with the spud;
the cap includes a base, a side wall extending from the base to define a cavity together with the base, and an annular skirt coupled to the side wall and having a peripheral rim distal from the side wall, and wherein insertion of the cap into the pass-through hollow prompts the annular skirt to elastically deform from a first position, wherein the peripheral rim is a first distance from the side wall, to a second position, wherein the annular skirt is in contact with the threaded portion of the spud and the peripheral rim is a second distance from the side wall, and resiliently rebound back from the second position to a third position, wherein the peripheral rim is positioned within an annular channel of the spud and the peripheral rim is a third distance from the side wall, the first and third distances being greater than the second distance;
the first distance is greater than the third distance;
the first distance is equal to the third distance; and
the cap is plastically deformed and removed from the pass-through hollow through the outer opening, such that the entirety of the cap is separated from the spud.

According to a third aspect of the present disclosure, a method of manufacturing a tank for holding hot water includes the steps of concealing a threaded portion of a spud coupled to the tank from an interior volume defined by an interior surface of the tank with a membrane by arranging the membrane relative to a pass-through hollow that is defined by the spud and that extends from an outer opening that is distal from the tank to an inner opening that is proximal to the tank, applying a coating to the interior surface of the tank, and revealing the threaded portion of the spud to the interior volume by plastically deforming the membrane to extract the membrane through the outer opening of the pass-through hollow.
the step of welding the membrane to the spud;
the membrane is plastically deformed and extracted through the outer opening of the pass-through hollow, such that the entirety of the membrane is separated from the spud;
the membrane forms a cap, and the cap is inserted into the pass-through hollow to conceal the threaded portion of the spud from the interior volume; and
the cap elastically deforms during insertion of the cap into the pass-through hollow due to contact with the spud.

According to a fourth aspect of the present disclosure, a cap for insertion into a spud of a water heater includes a base, a side wall extending from the base to define a cavity together with the base, and a flange coupled to the side wall and extending outward therefrom to a peripheral rim. The flange includes a first side and a second side that is opposite the first side and further than the first side from the base. At least one of the first side of the flange and the second side of the flange includes a plurality of grooves.

Embodiments of the fourth aspect of the present disclosure can include any one or a combination of the following features:
the plurality of grooves extend outward along the flange in radial fashion;
the second side of the flange includes the plurality of grooves;
the second side of the flange includes an annular groove that is positioned radially between the peripheral rim and the side wall of the flange and intersects the plurality of grooves extending outward along the second side of the flange in radial fashion;
the first side of the flange includes the plurality of grooves;
the first and second sides of the flange include the plurality of grooves;
the plurality of grooves are arranged such that, for a given groove extending outward along one of the first side and the second side of the flange in radial fashion, a pair of grooves that are circumferentially adjacent to the given groove extend outward along the other of the first side and the second side of the flange in radial fashion;
the plurality of grooves extend to the peripheral rim of the flange; and
an outer diameter of the side wall is about a third of a diameter of the peripheral rim of the flange.

According to a fifth aspect of the present disclosure, an extraction tool for extracting a cap from a spud of a water heater includes a housing that defines an output feature housing region and includes a mouth that defines a mouth hollow in communication with the output feature housing region and a mouth opening distal from the output feature housing region. The extraction tool further includes an output feature disposed within the output feature housing region of the housing and operable to move between a first position and a second position within the output feature housing region responsive to actuation of an actuator operably coupled thereto. The extraction tool further includes a plurality of engagement fingers operably coupled with the output feature and extending within the mouth hollow, wherein movement of the output feature from the first position to the second position prompts movement of the plurality of engagement fingers relative to the output feature from disengaged positions, wherein the plurality of engagement fingers are configured to extend within a pass-through hollow of the spud and along a side wall of the cap, to engaged positions, wherein the plurality of engagement fingers are configured to impinge on the side wall of the cap to plastically deform the side wall radially-inboard.

Embodiments of the fifth aspect of the present disclosure can include any one or a combination of the following features:
the output feature is operable to translate away from the mouth of the housing from the first position to the second position within the output feature housing region;
the plurality of engagement fingers are pivotably coupled with the output feature, and translation of the output feature from the first position to the second position prompts pivotal movement of the plurality of engagement fingers relative to the output feature from the disengaged positions to the engaged positions;
the mouth includes an interior surface that defines the mouth hollow, and the interior surface of the mouth includes a tapered portion that extends radially inboard as the tapered portion extends axially toward the output feature, and wherein movement of the plurality of engagement fingers with the output feature as the output feature translates from the first position to the second position causes the engagement fingers to interfere with the tapered portion which prompts pivotal movement of the plurality of engagement fingers to the engaged positions; and
each of the plurality of engagement fingers extends from a first end to a second end and includes a radially inboard surface that is configured to impinge on the side wall of the cap in the engaged position and a radially outboard surface opposite the radially inboard surface, wherein the radially outboard surface includes a protruding portion that extends radially outboard proximate to the second end of the engagement finger, and the protruding portion interferes with the tapered portion due to movement of the engagement finger with the output feature as the output feature translates from the first position to the second position.

According to a sixth aspect of the present disclosure, a method of manufacturing a tank for holding hot water includes the steps of concealing a threaded portion of a spud coupled to the tank from an interior volume defined by an interior surface of the tank with a cap by inserting the cap into a pass-through hollow that is defined by the spud and that extends from an outer opening that is distal from the tank to an inner opening that is proximal to the tank, applying a coating to the interior surface of the tank, and revealing the threaded portion of the spud to the interior volume by plastically deforming the cap to remove the cap from the pass-through hollow through the outer opening.

Embodiments of the sixth aspect of the present disclosure can include any one or a combination of the following steps and/or features:
aligning an extraction tool with the cap, such that a plurality of engagement fingers of the extraction tool extend within the pass-through hollow of the spud and along a side wall of the cap, and actuating an actuator of the extraction tool, such that the plurality of engagement fingers move from disengaged positions to engaged positions to impinge on the side wall of the cap, wherein the impingement on the side wall of the cap plastically deforms the cap to allow removal of the cap from the pass-through hollow through the outer opening;
the step of securing the cap to the spud via a plurality of tabs of the spud that extend along a flange of the cap;
the cap is inserted into the pass-through hollow through the inner opening toward the outer opening;
the cap is plastically deformed and removed from the pass-through hollow through the outer opening, such that the entirety of the cap is separated from the spud; and
the cap includes a base, a side wall extending from the base to define a cavity together with the base, and a flange coupled to the side wall and extending outward therefrom to a peripheral rim. The flange includes a first side and a second side that is opposite the first side and further than the first side from the base. At least one of the first side of the flange and the second side of the flange includes a plurality of grooves.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front perspective view of a water heater, according to one embodiment;

FIG. 2 is a cross-sectional view of the water heater of FIG. 1 taken at line II-II, illustrating a shell of the water heater, a tank disposed within the shell, a spud coupled to the tank, and a fitting engaged with the spud, according to one embodiment;

FIG. 3 is a cross-sectional view of the spud coupled to a portion of the tank of the water heater, according to one embodiment;

FIG. 4 is a top perspective view of a spud and a cap that has an annular skirt and is configured to be inserted into a pass-through hollow defined by the spud, according to one embodiment;

FIG. 5 is a cross-sectional view of a portion of a tank, a spud coupled to the portion of the tank, and a cap in a spaced-relationship with the spud, such that a peripheral rim of an annular skirt of the cap is a first distance from a side wall of the cap, according to one embodiment;

FIG. 6 is a cross-sectional view of the portion of the tank, the spud, and the cap, wherein the peripheral rim of the annular skirt is a second distance from the side wall of the cap due to contact between the annular skirt and a threaded portion of the spud, according to one embodiment;

FIG. 7 is a cross-sectional view of the portion of the tank, the spud coupled to the tank, and the cap, wherein the cap is inserted into a pass-through hollow defined by the spud, such that the peripheral rim of the annular skirt is received within an annular channel of the spud and the peripheral rim is a third distance from the side wall of the cap, according to one embodiment;

FIG. 8 is a top perspective view of a spud and a cap that is configured to be inserted into a pass-through hollow defined by the spud, according to one embodiment;

FIG. 9 is a cross-sectional view of a portion of a tank, a spud coupled to the tank, and a cap that is inserted into the pass-through hollow defined by the spud, according to one embodiment;

FIG. 10 is a top perspective view of a spud and a cap that is configured to be received within a pass-through hollow defined by the spud, according to one embodiment;

FIG. 11 is a cross-sectional view of a portion of a tank of a water heater, a spud coupled to the tank, and a cap that is inserted into a pass-through hollow defined by the spud, according to one embodiment;

FIG. 12 is a perspective view of a cap, illustrating a flange that includes a plurality of grooves, according to one embodiment;

FIG. 13 is a perspective view of a cap, illustrating a flange that includes a plurality of groove, according to one embodiment;

FIG. 14 is an elevational view of a cap that includes a flange that includes a plurality of grooves, according to one embodiment;

FIG. 15 is a top perspective view of a spud and a cap that is configured to be received within a pass-through hollow defined by the spud, according to one embodiment;

FIG. 16 is a cross-sectional view of a portion of a tank, a spud coupled to the tank, and a cap that is inserted into the pass-through hollow defined by the spud, according to one embodiment;

FIG. 17 is a perspective view of a cap, illustrating a flange of the cap, according to one embodiment;

FIG. 18 is a perspective view of a cap, illustrating a flange of the cap that includes a plurality of grooves that extend in radial fashion to a peripheral rim of the flange and an annular groove that extends circumferentially along the flange and intersects with the plurality of grooves, according to one embodiment;

FIG. 19 is a bottom plan view of a cap, illustrating a flange of the cap that includes a plurality of grooves that extend in radial fashion to a peripheral rim of the flange and an annular groove that extends circumferentially along the flange and intersects with the plurality of grooves, according to one embodiment;

FIG. 20 is a top perspective view of a spud and a cap that is configured to be received within a pass-through hollow defined by the spud, according to one embodiment;

FIG. 21 is a cross-sectional view of a portion of a tank of water heater, a spud coupled the tank, and a cap that is inserted into a pass-through hollow defined by the spud, according to one embodiment;

FIG. 22 is a perspective view of a cap that has been plastically deformed in a radially inboard direction, according to one embodiment;

FIG. 23 is a top perspective of an extraction tool, according to one embodiment;

FIG. 24 is a cross-sectional view of the extraction tool of FIG. 23 taken at line XXIV-XXIV, illustrating a housing, an output feature disposed within the housing, and a plurality of engagement fingers operably coupled to the output feature and disposed about a cap, according to one embodiment;

FIG. 25 is a cross-sectional view of an extraction tool that includes an output feature disposed in a first position, a spud that is aligned with a mouth of a housing of the extraction tool such that the mouth extends into a pass-through hollow defined by the spud, and a cap that is inserted into the spud and received radially inboard of a plurality of engagement fingers of the extraction tool, according to one embodiment;

FIG. 26 is a cross-sectional view of the extraction tool of FIG. 25, illustrating the output feature in a second position and the plurality of engagement fingers in engaged positions relative to the cap, such that the engagement fingers impinge on a side wall of the cap to plastically deform the side wall radially inboard, according to one embodiment; and

FIG. 27 is a block diagram of a method of manufacturing a tank for holding hot water, according to one embodiment.

### DETAILED DESCRIPTION OF PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along an axis extending through a pass-through hollow of a spud that has a threaded portion, wherein a corresponding threaded fitting is configured to be engaged with the threaded portion of the spud via rotation of the threaded fitting about the axis. Further, the term “radial” and derivatives thereof, such as “radially,” shall be understood in relation to the axis of the aforementioned spud. For example, “radially outboard” refers to further away from the axis, while “radially inboard” refers to nearer to the axis. The term “circumferential” and derivatives thereof, such as “circumferentially,” shall be understood in relation to the axis of the aforementioned spud. Further, “axial,” “radial,” and “circumferential” and derivatives thereof, as they relate to the axis of the spud, can be applied to other components that are configured to be arranged proximate to the spud. For example, characteristics and/or movement of a cap that is inserted into the pass-through hollow defined by the spud and/or an extraction tool that is operable to be aligned with the spud can be described with the terms “axial,” “radial,” and “circumferential” and derivatives thereof.

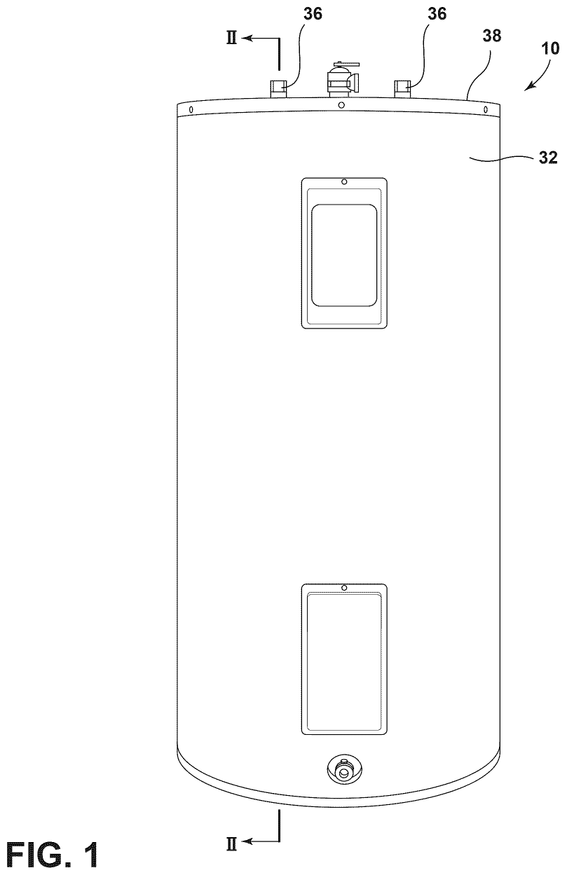

Referring now to FIGS. 1-12, a water heater 10 includes a tank 12 and a spud 14 coupled to the tank 12. A cap 16 is configured to be inserted into the spud 14. The cap 16 includes a base 18, a side wall 20 extending from the base 18 to define a cavity 22 together with the base 18, and an annular skirt 24 coupled to the side wall 20. The annular skirt 24 has a peripheral rim 26 that is distal from the side wall 20. The annular skirt 24 is operable to elastically deform from a first position, wherein the annular skirt 24 is not in contact with the spud 14 and the peripheral rim 26 is a first distance from the side wall 20, to a second position, wherein the annular skirt 24 is in contact with a threaded portion 28 of the spud 14 and the peripheral rim 26 is a second distance from the side wall 20. The annular skirt 24 is operable to resiliently rebound back from the second position to a third position, wherein the peripheral rim 26 is positioned within an annular channel 30 of the spud 14 and the peripheral rim 26 is a third distance from the side wall 20. The first and third distances are greater than the second distance.

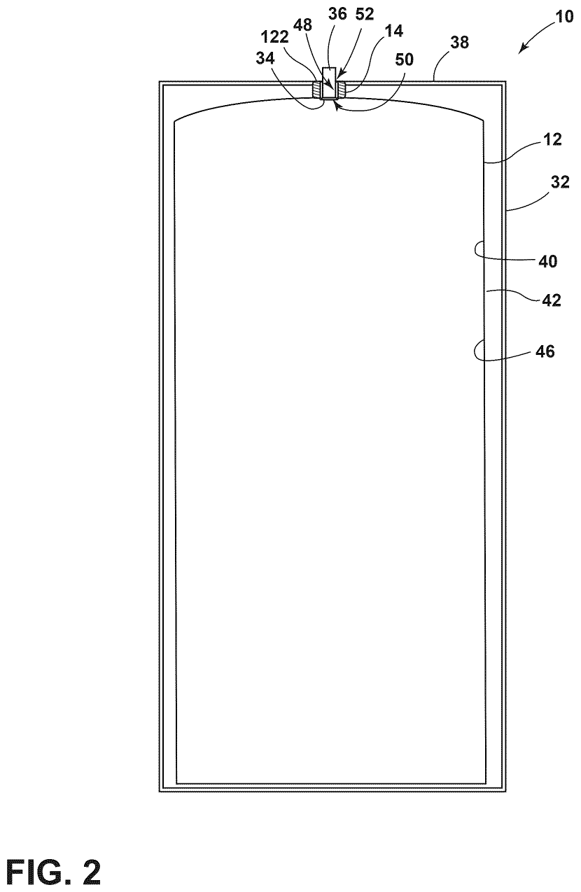

Referring now to FIGS. 1 and 2, the water heater 10 is illustrated. The water heater 10 includes an outer shell 32, as illustrated in FIG. 1. The tank 12 of the water heater 10 is housed within the outer shell 32, as illustrated in FIG. 2. In various implementations, the tank 12 includes one or more ports 34, such as a cold water inlet port and/or a hot water outlet port. In the exemplary embodiment of the water heater 10 depicted in FIG. 1, protruding fittings 36 that correspond with the cold water inlet port and the hot water outlet port defined by the tank 12 are positioned proximate to a top 38 of the water heater 10. Accordingly, the ports 34 defined by the tank 12 in the exemplary embodiment are defined proximate to the top of the tank 12, as illustrated in FIG. 2, wherein the hot water outlet port is shown. The one or more ports 34 of the tank 12 of the water heater 10 extend through the tank 12 from an interior surface 40 of the tank 12 to an exterior surface 42 of the tank 12 opposite the interior surface 40. The interior surface 40 of the tank 12 defines an interior volume 44 that is configured to hold water and can have a coating 46 applied thereto, as described further herein.

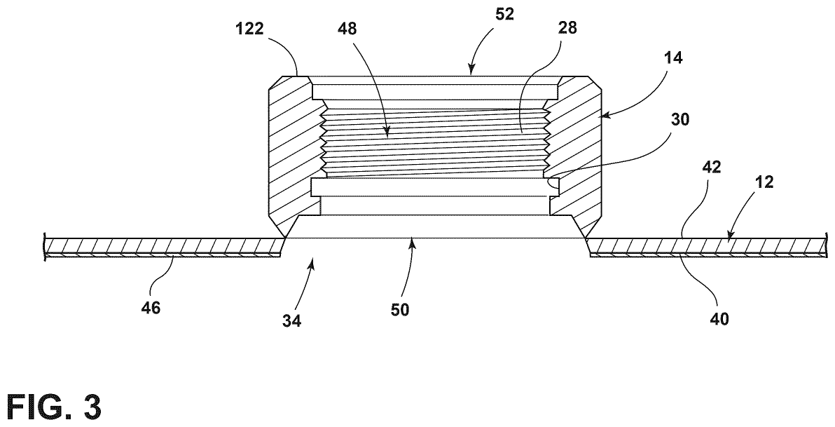

Referring now to FIGS. 1-3, the water heater 10 includes the spud 14. The spud 14 may be coupled to the tank 12 of the water heater 10 and may define a pass-through hollow 48 that extends from an inner opening 50 to an outer opening 52. As illustrated in FIG. 3, the spud 14 is coupled to the tank 12, such that the port 34 defined by the tank 12 corresponds with the pass-through hollow 48 defined by the spud 14. Water is operable to flow into and/or out of the tank 12 through the pass-through hollow 48 and the corresponding port 34 defined by the tank 12. As illustrated in FIG. 3, the inner opening 50 of the pass-through hollow 48 defined by the spud 14 is proximal to the tank 12, and the outer opening 52 of the pass-through hollow 48 is distal from the tank 12. In various implementations, the spud 14 includes a threaded portion 28 that is configured to be engaged with corresponding threads of the fitting 36 of the water heater 10. In some implementations, the spud 14 can include an annular channel 30. The annular channel 30 can have a diameter that is greater than the largest diameter of the threaded portion 28 of the spud 14. In various implementations, the annular channel 30 can be positioned axially between the threaded portion 28 of the spud 14 and the inner opening 50 of the pass-through hollow 48, as illustrated in FIG. 3. As shown in FIG. 2, the fitting 36 is disposed within the pass-through hollow 48 of the spud 14 that is coupled to the tank 12 and that corresponds with the hot water outlet port defined by the tank 12. It is contemplated that the water heater 10 can include various additional components that are not shown herein, such as heating elements, burner assemblies, and/or heat exchangers.

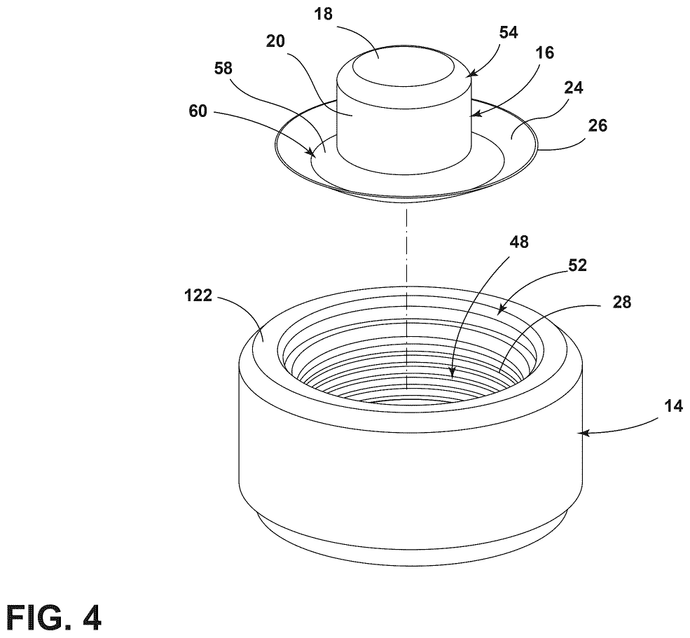

Referring now to FIGS. 4-21, a membrane 54 may be arranged relative to the pass-through hollow 48 that is defined by the spud 14 to conceal the threaded portion 28 of the spud 14 from the interior volume 44 defined by the interior surface 40 of the tank 12. The membrane 54 can be a metal membrane, such as a carbon steel membrane. In various embodiments, the membrane 54 forms the cap 16, as illustrated exemplarily in FIGS. 4-21. The cap 16 of the membrane 54 is configured to be inserted into the pass-through hollow 48 that is defined by the spud 14 to conceal the threaded portion 28 of the spud 14 that is coupled to the tank 12 from the interior volume 44 defined by the interior surface 40 of the tank 12.

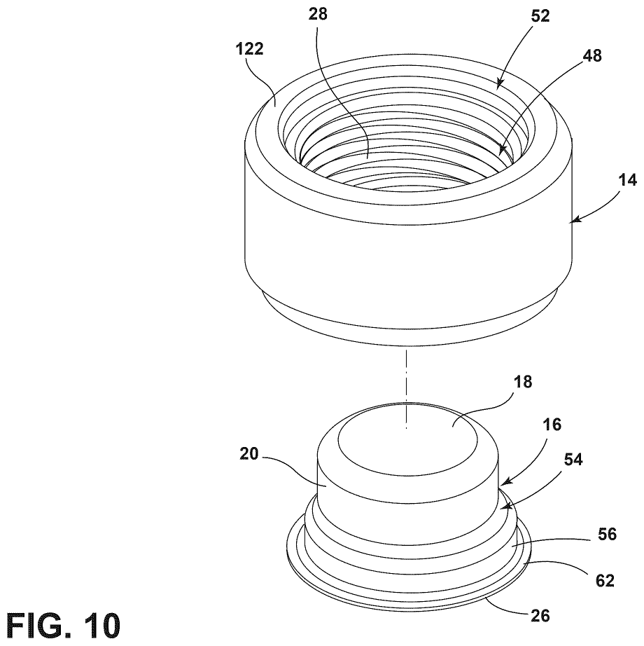

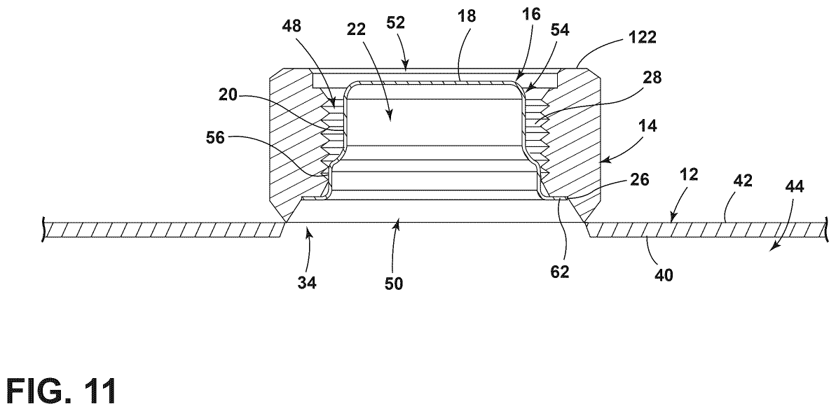

Referring still to FIGS. 4-21, in various embodiments, the cap 16 includes the base 18 and the side wall 20 that extends from the base 18 to define the cavity 22 together with the base 18. In the embodiments of the cap 16 illustrated in FIGS. 4-21, the base 18 and the side wall 20 that define the cavity 22 cooperate to form a portion of the cap 16 that is cup-shaped. In the illustrated embodiments, the base 18 extends radially when the cap 16 is inserted into the pass-through hollow 48. The side wall 20 extends axially from the base 18 and circumferentially along the axial extent of the side wall 20 when the cap 16 is inserted into the pass-through hollow 48 to form the cup-shaped portion of the cap 16 together with the base 18. In some embodiments, the side wall 20 of the cap 16 can include a shoulder portion 56 that has a larger diameter relative to a portion of the side wall 20 that is nearer than the shoulder portion 56 to the base 18 of the cap 16. For example, as illustrated in FIGS. 10 and 11, the side wall 20 of the cap 16 includes the shoulder portion 56 that is configured to contact a portion of the spud 14 when the cap 16 is inserted into the pass-through hollow 48 to form a friction fit with the spud 14, as described further herein.

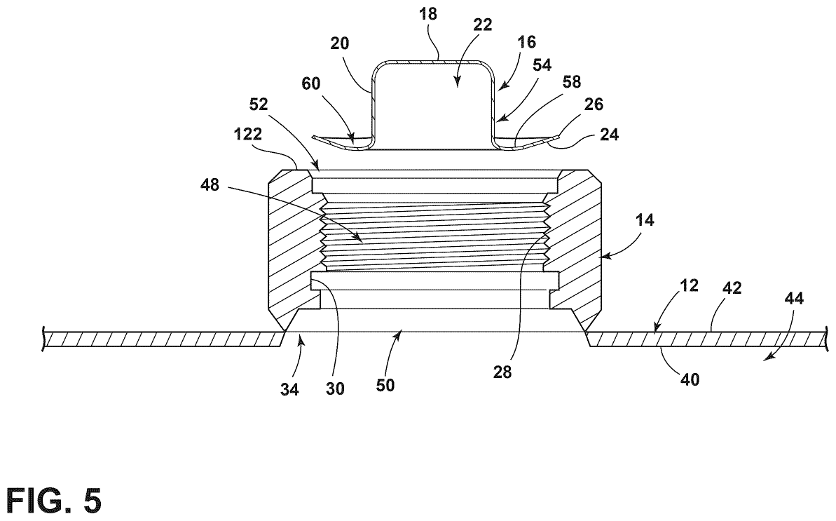

Referring now to FIGS. 4-7, in some embodiments, the cap 16 includes the annular skirt 24. The annular skirt 24 may be coupled to the side wall 20, as illustrated exemplarily in FIGS. 4-7. The annular skirt 24 includes the peripheral rim 26 that is distal from the side wall 20 of the cap 16. As illustrated in FIGS. 4 and 5, the annular skirt 24 includes an arcuate portion 58. The arcuate portion 58 of the annular skirt 24 can extend annularly and form an annular concave depression 60. As illustrated in FIGS. 4 and 5, the annular concave depression 60 is oriented toward the base 18 of the cap 16. In other words, the annular concave depression 60 faces a first axial direction with respect to the spud 14 when the cap 16 is inserted into the pass-through hollow 48, and the base 18 of the cap 16 is axially offset from the annular concave depression 60 in the first axial direction. In various implementations, the annular skirt 24 is operable to elastically deform between various positions during insertion of the cap 16 into the pass-through hollow 48 defined by the spud 14. In some implementations, the arcuate portion 58 of the annular skirt 24 elastically deforms, as described further herein.

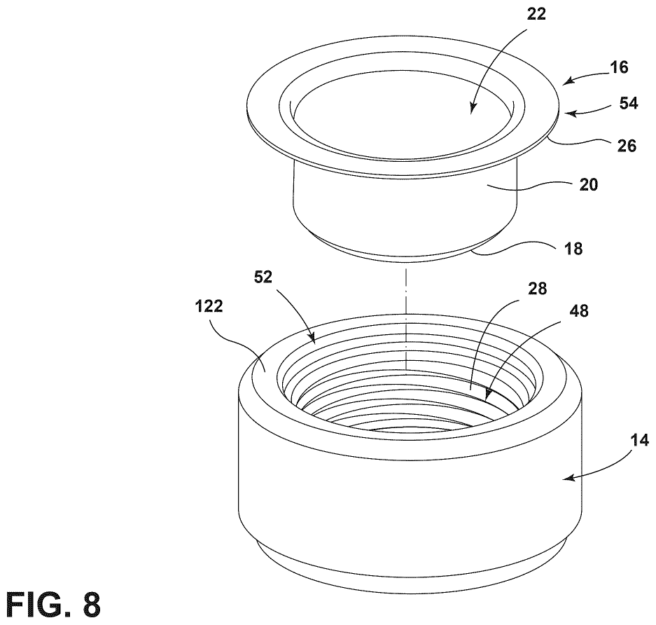

Referring now to FIGS. 8-21, in some embodiments, the cap 16 can include a flange 62 that extends outward from a distal end portion of the side wall 20 that is distal from the base 18 of the cap 16 to the peripheral rim 26. The flange 62 includes a first side 64 and a second side 66 that is opposite the first side 64. The second side 66 of the flange 62 may be further than the first side 64 of the flange 62 from the base 18, as illustrated in FIG. 14. In various implementations, while the cap 16 is inserted into the pass-through hollow 48 defined by the spud 14, the flange 62 extends radially outward at an angle that is perpendicular to the axial direction of the spud 14. The flange 62 may be in contact with and/or affixed to the spud 14 in order to restrict axial movement of the cap 16 relative to the spud 14 in at least one axial direction. In some implementations, an outer diameter of the side wall 20 of the cap 16 is about a third of a diameter of the peripheral rim 26 of the flange 62. For example, in some implementations, the outer diameter of the side wall 20 may be about 0.35 inches, and the diameter of the peripheral rim 26 may be about 1.05 inches. The outer diameter of the side wall 20 being sized relative to the diameter of the peripheral rim 26 in this way advantageously allows adequate space for engagement fingers 68 of an extraction tool 70 to extend within the pass-through hollow 48 of the spud 14 and along the radially-outboard side of the side wall 20 of the cap 16.

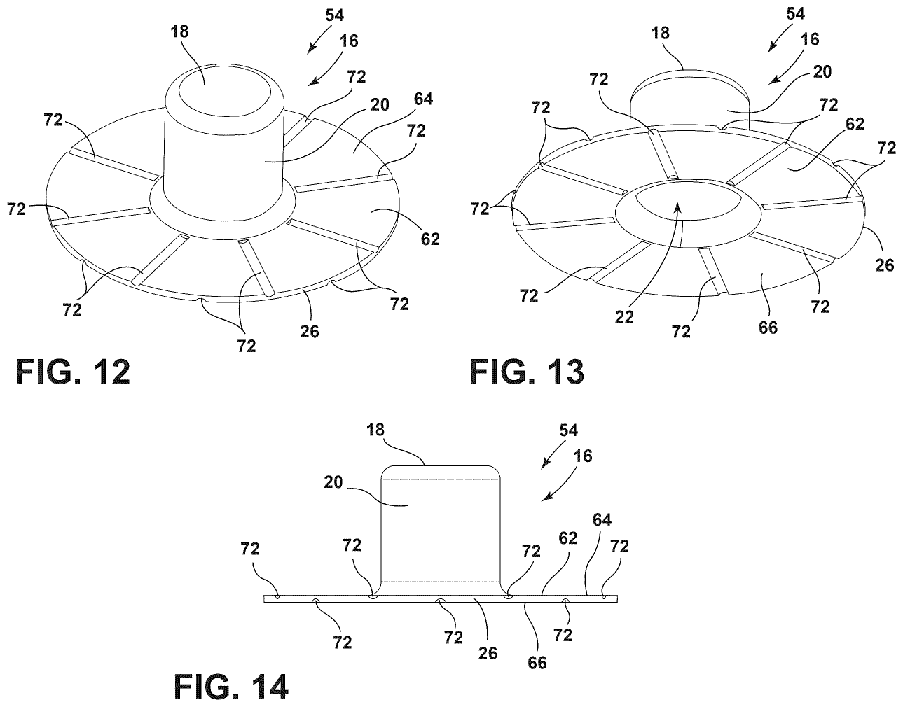

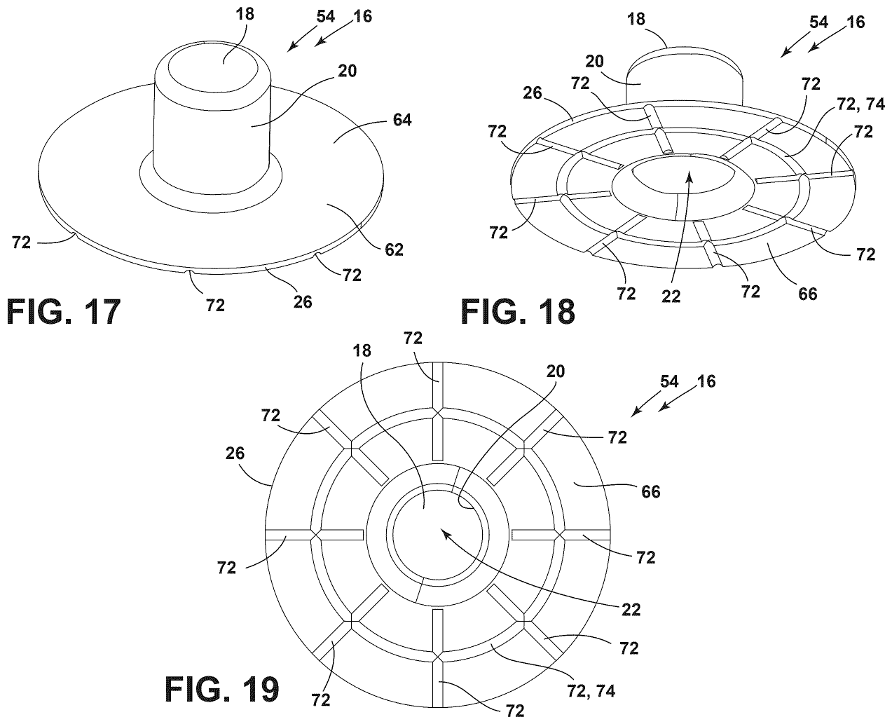

Referring now to FIGS. 12-21, the flange 62 of the cap 16 may include a plurality of grooves 72. In various embodiments, at least one of the first side 64 of the flange 62 and the second side 66 of the flange 62 includes the plurality of grooves 72. For example, in the embodiment illustrated in FIGS. 12-16, the first and second sides 64, 66 of the flange 62 includes the plurality of grooves 72. In the exemplary embodiment illustrated in FIGS. 17-21, the second side of the flange 62 includes the plurality of grooves 72 and the first side 64 of the flange 62 of the cap 16 omits grooves 72. In some embodiments, the plurality of grooves 72 extend outward along the flange 62 of the cap 16 in radial fashion. For example, in the embodiment illustrated in FIGS. 12-14, the cap 16 includes the plurality of grooves 72 that extend outward in radial fashion on the first and second sides 64, 66 of the flange 62. Further, in the embodiment illustrated in FIGS. 17-19, the second side 66 of the flange 62 includes a plurality of grooves 72 that extend outward in radial fashion.

In some embodiments, the plurality of grooves 72 extend outward to the peripheral rim 26 of the flange 62. For example, as illustrated in FIGS. 12-14 and 17-19, the grooves 72 of the flange 62 extend to the peripheral rim 26 of the flange 62. In some embodiments, the plurality of grooves 72 extend radially outward and terminate radially inboard of the peripheral rim 26 of the flange 62. In some implementations, wherein the first and second sides 64, 66 of the flange 62 include the plurality of grooves 72, the plurality of grooves 72 are arranged such that, for a given groove 72 extending outward along one of the first side 64 and the second side 66 of the flange 62 in radial fashion, a pair of grooves 72 that are circumferentially adjacent to the given groove 72 extend outward along the other of the first side 64 and the second side 66 of the flange 62 in radial fashion, as is illustrated exemplarily in FIGS. 12-14.

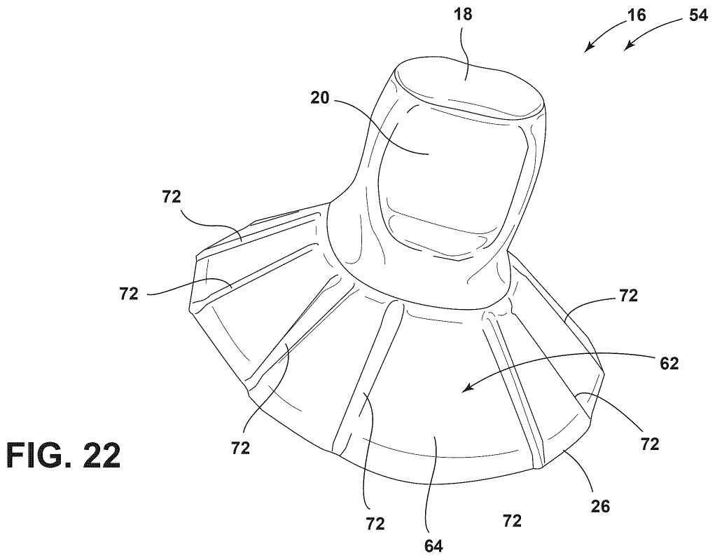

In some implementations, the flange 62 can include an annular groove 74. The annular groove 74 may be positioned radially between the peripheral rim 26 and the side wall 20 of the flange 62 and may intersect the plurality of grooves 72 that extend outward along flange 62 in radial fashion. For example, as illustrated in FIGS. 17-19, the second side 66 of the flange 62 includes the plurality of grooves 72 that extend outward in radial fashion and the annular groove 74. The annular groove 74 is positioned radially between the peripheral rim 26 and the side wall 20 of the flange 62 and intersects the plurality of grooves 72 that extend outward along the second side 66 of the flange 62 in radial fashion. In various embodiments, the grooves 72 of the flange 62 of the cap 16 may influence how the flange 62 of the cap 16 deforms, such that a desirable deformation of the cap 16 may be achieved to allow for extraction of the cap 16 from the spud 14, as illustrated exemplarily in FIG. 22 and described further herein.

Referring now to FIGS. 4-21, in some embodiments, the cap 16 may be inserted into the pass-through hollow 48 defined by the spud 14 through the outer opening 52 toward the inner opening 50, as illustrated exemplarily in FIGS. 4-9. In some implementations, the cap 16 is configured to be inserted into the pass-through hollow 48 through the inner opening 50 toward the outer opening 52, as illustrated exemplarily in FIGS. 10, 11, 15, 16, 20, and 21. In the inserted position of the cap 16, the cap 16 is configured to conceal the threaded portion 28 of the spud 14 from the interior volume 44 defined by the interior surface 40 of the tank 12. Concealing the threaded portion 28 of the spud 14 in this way may prevent the coating 46 that is applied to the interior surface 40 of the tank 12 from coating the threaded portion 28 of the spud 14 in an undesirable manner.

In the manufacturing process of the water heater 10 and in particular the tank 12 of the water heater 10, applying the coating 46 to the interior surface 40 of the tank 12 can help prevent the tank 12 from rusting. In an exemplary embodiment, applying the coating 46 to the interior surface 40 of the tank 12 includes spraying unfired glass onto the interior surface 40 of the tank 12. It is contemplated that applying the coating 46 to the interior surface 40 of the tank 12 can include the application of a variety of types of coatings 46 (e.g., porcelain, ceramic, polymer, organic material, electroplating, etc.).

In various implementations, after the coating 46 is applied to the interior surface 40 of the tank 12, the cap 16 is removed from the spud 14 to reveal the threaded portion 28 of the spud 14. In various embodiments, the cap 16 is removed from the pass-through hollow 48 of the spud 14 through the outer opening 52. In some implementations, the cap 16 is plastically deformed by, for example, the extraction tool 70 to remove the cap 16 from the pass-through hollow 48 through the outer opening 52, as described further herein.

Referring now to FIGS. 4-7, an exemplary embodiment of the spud 14 and the cap 16 is illustrated. The spud 14 includes the threaded portion 28 and the annular channel 30 that is positioned axially between the inner opening 50 of the pass-through hollow 48 and the threaded portion 28 of the spud 14. The cap 16 includes the base 18, the side wall 20, and the annular skirt 24 that includes the peripheral rim 26 that is distal from the side wall 20. The annular skirt 24 includes the arcuate portion 58 that forms the annular concave depression 60.

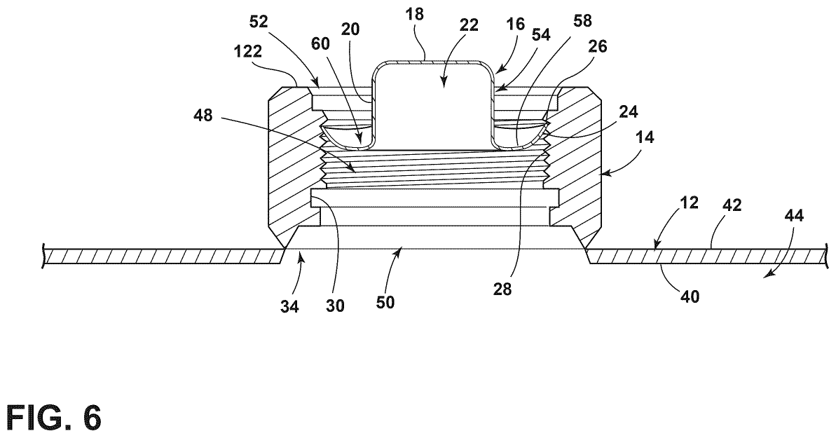

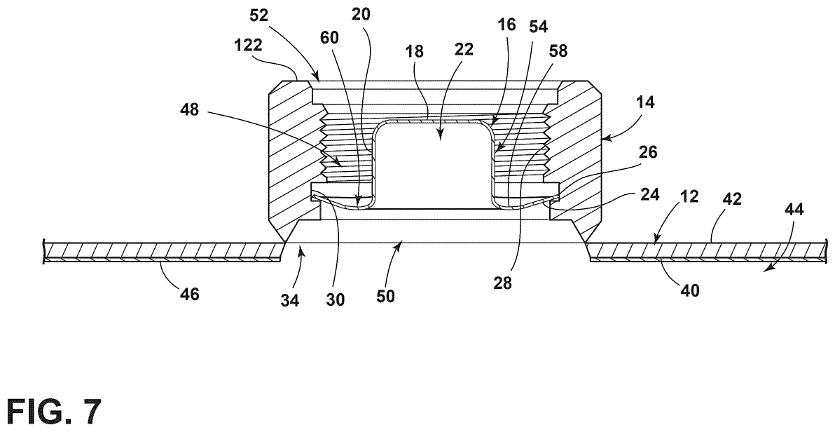

In operation of the exemplary embodiment illustrated in FIGS. 4-7, the annular skirt 24 elastically deforms at the arcuate portion 58 from a first position (FIG. 5), wherein the annular skirt 24 is not in contact with the spud 14 and the peripheral rim 26 is a first distance from the side wall 20, to a second position. In the second position (illustrated in FIG. 6), the annular skirt 24 is in contact with the threaded portion 28 of the spud 14 and the peripheral rim 26 is a second distance from the side wall 20. The annular skirt 24 is operable to resiliently rebound back from the second position to a third position. In the third position (illustrated in FIG. 7), the peripheral rim 26 is positioned within the annular channel 30 of the spud 14 and the peripheral rim 26 is a third distance from the side wall 20. The first and third distances are greater than the second distance. In some embodiments, the first distance is greater than the third distance. In some embodiments, the first distance is equal to the third distance. In the exemplary embodiment illustrated in FIGS. 4-7, the cap 16 is formed of metal.

After the coating 46 is applied to the interior surface 40 of the tank 12, the cap 16 illustrated in FIGS. 4-7 may be removed from the pass-through hollow 48 defined by the spud 14 via plastic deformation and extraction through the outer opening 52 of the pass-through hollow 48. In the exemplary implementation, an extraction tool 70 is utilized to grip the side wall 20 of the cap 16 and pull the cap 16 out of the pass-through hollow 48 through the outer opening 52. This process may plastically deform the cap 16 at the side wall 20 and/or the annular skirt 24, due to the gripping of the side wall 20 with the extraction tool 70 and/or the forced movement of the annular skirt 24 out of the annular channel 30 of the spud 14 during removal. Other removal processes are contemplated. For example, in some implementations, the cap 16 may be pushed through the inner opening 50 out of the pass-through hollow 48. The annular skirt 24 may elastically deform to allow removal in this manner.

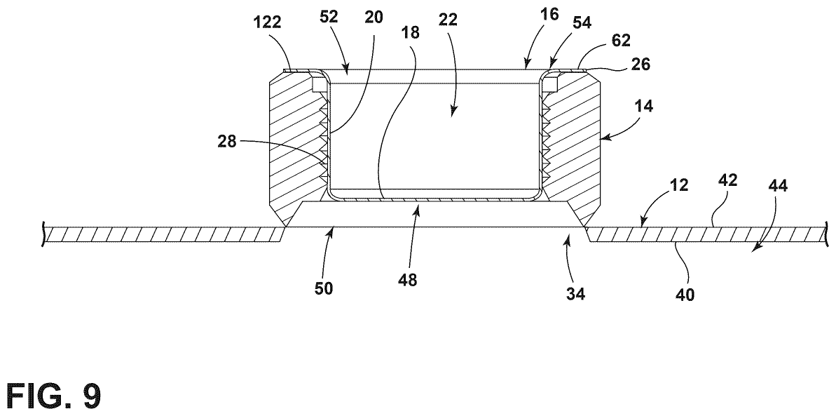

Referring now to FIGS. 8 and 9, an exemplary embodiment of the spud 14 and the cap 16 is illustrated. The spud 14 defines the pass-through hollow 48 that extends from the inner opening 50 to the outer opening 52 and includes the threaded portion 28. The cap 16 includes the base 18, the side wall 20 extending from the base 18, and the flange 62 that extends outward from the side wall 20. In operation of the exemplary embodiment illustrated in FIGS. 8 and 9, the cap 16 is inserted into the pass-through hollow 48 defined by the spud 14 via the outer opening 52, such that the side wall 20 and base 18 conceal the threaded portion 28 of the spud 14 from the interior volume 44 defined by the interior surface 40 of the tank 12, and the flange 62 contacts a portion of the spud 14 proximate the outer opening 52 of the pass-through hollow 48. The cap 16 is then welded to the spud 14 at the flange 62 to secure the cap 16 in place. After the coating 46 is applied to the interior surface 40 of the tank 12, the cap 16 is plastically deformed by, for example, the extraction tool 70 and removed from the pass-through hollow 48 through the outer opening 52.

Referring now to FIGS. 10 and 11, an exemplary embodiment of the spud 14 and the cap 16 is illustrated. In the exemplary embodiment, the spud 14 defines the pass-through hollow 48 that extends from the inner opening 50 to the outer opening 52, and the spud 14 includes the threaded portion 28. The cap 16 includes the base 18, the side wall 20 extending from the base 18, and the flange 62 extending outward from the side wall 20. The side wall 20 includes the shoulder portion 56 that has a larger diameter relative to a portion of the side wall 20 that is disposed between the shoulder portion 56 and the base 18 of the cap 16.

In operation of the exemplary embodiment, the cap 16 is inserted into the pass-through hollow 48 defined by the spud 14 through the inner opening 50 to conceal the threaded portion 28 of the spud 14 from the interior volume 44 of the tank 12. As illustrated in FIG. 11, the shoulder portion 56 of the cap 16 contacts a portion of the spud 14 that defines the pass-through hollow 48, such that a friction fit between the cap 16 and the spud 14 is created to retain the cap 16 in the inserted position. After application of the coating 46 to the interior surface 40 of the tank 12 is completed, the cap 16 may be plastically deformed by, for example, the extraction tool 70 and removed from the pass-through hollow 48 through the outer opening 52 of the pass-through hollow 48.

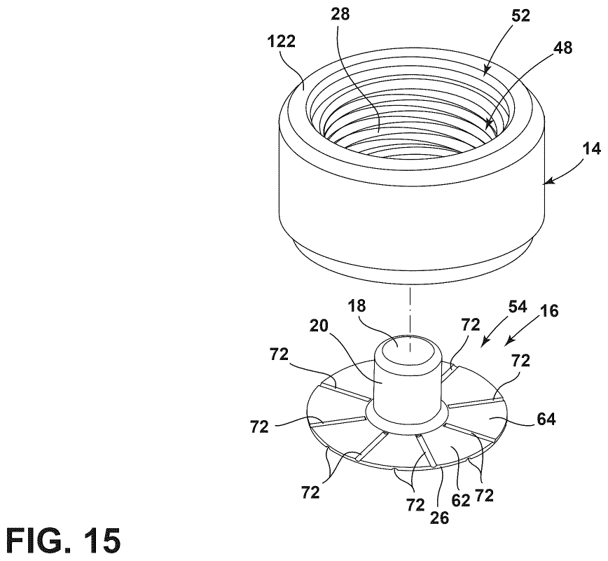

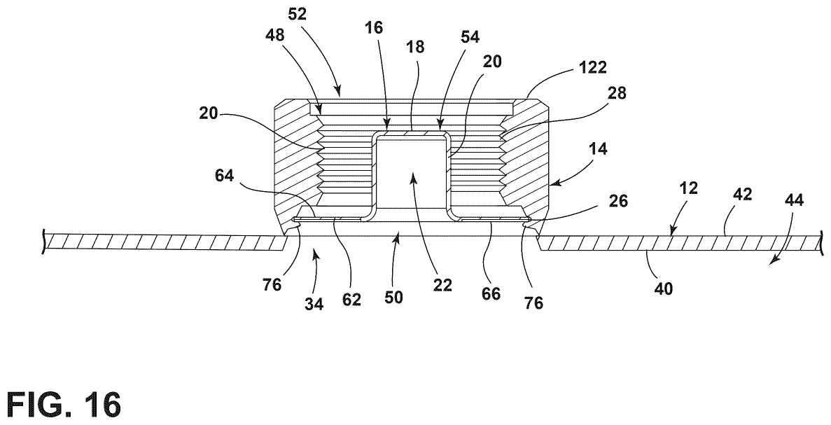

Referring now to FIGS. 15 and 16, an exemplary embodiment of the spud 14 and the cap 16 is illustrated. The spud 14 defines the pass-through hollow 48 that extends from the inner opening 50 to the outer opening 52 and includes the threaded portion 28. The cap 16 includes the base 18, the side wall 20 extending from the base 18, and the flange 62 that extends outward from the side wall 20 to the peripheral rim 26. The flange 62 includes a plurality of grooves 72 disposed on the first and second sides 64, 66 of the flange 62 and extending outward in radial fashion to the peripheral rim 26 of the flange 62.

In operation of the exemplary embodiment illustrated in FIGS. 15 and 16, the cap 16 is inserted into the pass-through hollow 48 defined by the spud 14 via the inner opening 50 to conceal the threaded portion 28 of the spud 14 from the interior volume 44 defined by the interior surface 40 of the tank 12. The flange 62 contacts a portion of the spud 14 proximate the inner opening 50 of the pass-through hollow 48. The cap 16 is then secured to the spud 14 via tabs 76 of the spud 14 that extend over a portion of the second side 66 of the flange 62 to maintain the cap 16 in an inserted position. After the coating 46 is applied to the interior surface 40 of the tank 12, the cap 16 is plastically deformed by the extraction tool 70, as described further herein, and removed from the pass-through hollow 48 through the outer opening 52. The grooves 72 disposed on the flange 62 of the cap 16 influence how the cap 16 deforms, such that after deformation, the configuration of the cap 16 is suitable for removal from the spud 14 through the outer opening 52.

Referring now to FIGS. 17-21, an exemplary embodiment of the spud 14 and the cap 16 is illustrated. The spud 14 defines the pass-through hollow 48 that extends from the inner opening 50 to the outer opening 52 and includes the threaded portion 28. The cap 16 includes the base 18, the side wall 20 extending from the base 18, and the flange 62 that extends outward from the side wall 20 to the peripheral rim 26. The flange 62 includes a plurality of grooves 72 disposed on the second side 66 of the flange 62 and extending outward in radial fashion to the peripheral rim 26 of the flange 62. The second side 66 of the flange 62 further includes the annular groove 74 that is positioned radially between the peripheral rim 26 of the flange 62 and the side wall 20 of the cap 16.

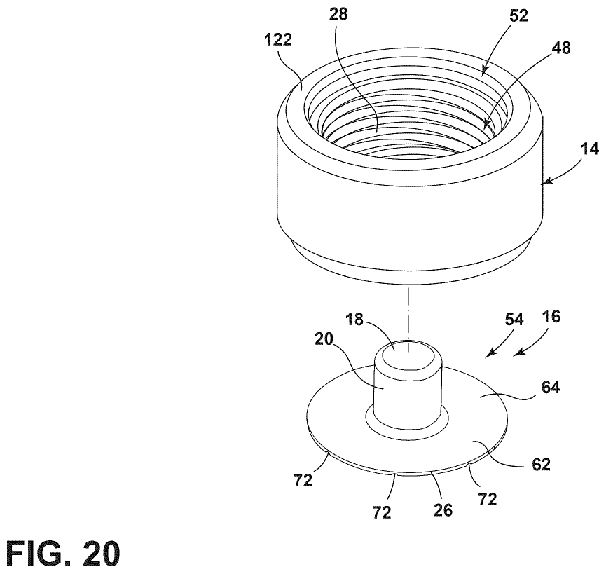

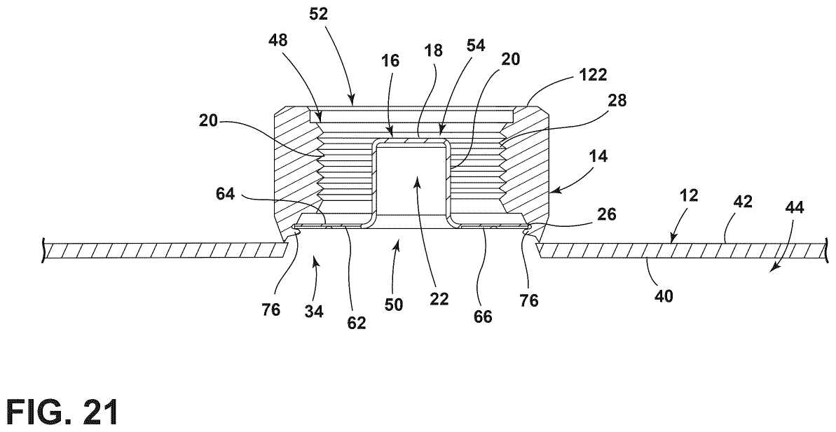

In operation of the exemplary embodiment illustrated in FIGS. 20 and 21, the cap 16 is inserted into the pass-through hollow 48 defined by the spud 14 via the inner opening 50 to conceal the threaded portion 28 of the spud 14 from the interior volume 44 defined by the interior surface 40 of the tank 12. The flange 62 contacts a portion of the spud 14 proximate the inner opening 50 of the pass-through hollow 48. The cap 16 is then secured to the spud 14 via tabs 76 of the spud 14 that extend over a portion of the second side 66 of the flange 62 to maintain the cap 16 in an inserted position. After the coating 46 is applied to the interior surface 40 of the tank 12, the cap 16 is plastically deformed by the extraction tool 70, as described further herein, and removed from the pass-through hollow 48 through the outer opening 52. The grooves 72 disposed on the flange 62 of the cap 16 influence how the cap 16 deforms, such that after deformation, the configuration of the cap 16 is suitable for removal from the spud 14 through the outer opening 52.

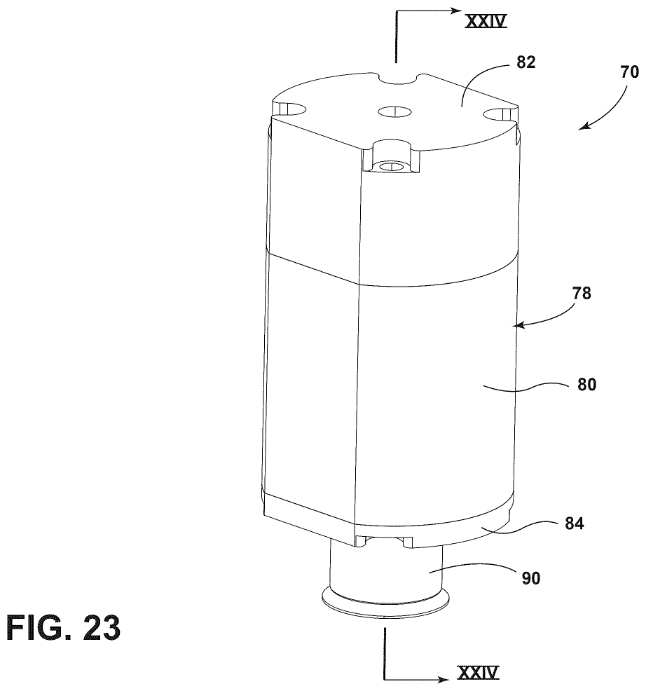

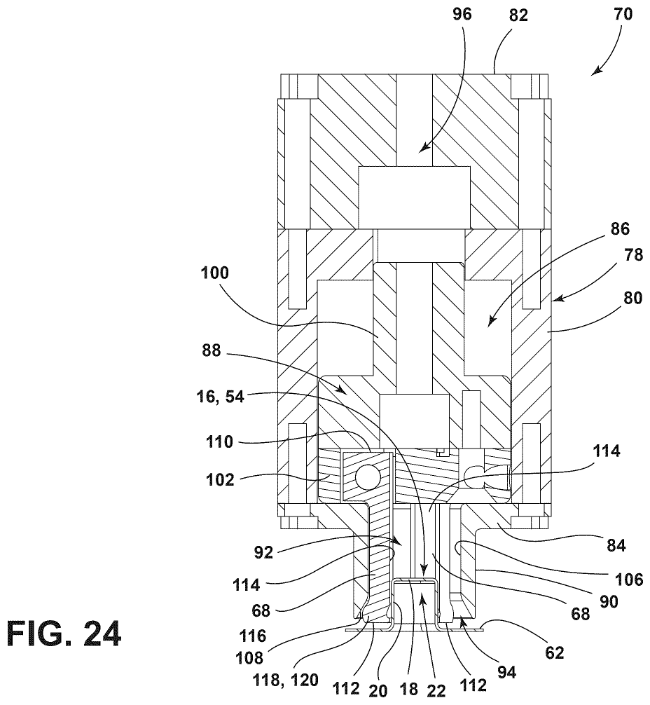

Referring now to FIGS. 23-26, the extraction tool 70 that is configured for extracting the cap 16 from the spud 14 of the water heater 10 is illustrated. The extraction tool 70 includes a housing 78. The housing 78 can be formed of a plurality of components. For example, the housing 78 may be an assembly of a plurality of die-cast metal components, in various implementations. In the embodiment illustrated in FIGS. 23-26, the housing 78 includes a central portion 80, a first end portion 82 that is configured to be fastened to the central portion 80, and a second end portion 84 that is configured to be fastened to the central portion 80 opposite the first end portion 82. In various implementations, the housing 78 defines an output feature housing region 86. The output feature housing region 86 may be configured to house an output feature 88 of the extraction tool 70 in various implementations, as described further herein. In some embodiments, the central portion 80 of the housing 78 defines the output feature housing region 86. In the embodiment illustrated in FIG. 24, the central portion 80 of the housing 78 and the second end portion 84 of the housing 78 cooperate to define the output feature housing region 86.

Referring still to FIGS. 23-26, in various implementations, the housing 78 includes a mouth 90. The mouth 90 defines a mouth hollow 92 that is in communication with the output feature housing region 86 and a mouth opening 94 that is distal from the output feature housing region 86. In various implementations, the second end portion 84 of the housing 78 forms the mouth 90 of the housing 78. In the embodiment illustrated in FIG. 24, the second end portion 84 of the housing 78 forms the mouth 90, which has a radial width that is smaller than the radial width of the portion of the housing 78 that defines the output feature housing region 86.

As further illustrated in FIG. 24, in various implementations, the housing 78 of the extraction tool 70 includes a passage 96 that extends from the output feature housing region 86 through an end of the housing 78 that is opposite the mouth opening 94 defined by the mouth 90 of the housing 78. For example, in the embodiment illustrated in FIG. 24, the first end portion 82 of the housing 78 defines a passage 96 that extends from an opening of the passage 96 to the output feature housing region 86. As such, the housing 78 may define an interior volume that extends from the opening of the passage 96 at the first end portion 82 of the housing 78 to the mouth opening 94 defined at the second end portion 84 of the housing 78, in some implementations. The passage 96 that extends from the opening of the first end portion 82 to the output feature housing region 86 of the housing 78 may provide access to the output feature housing region 86 of the housing 78, such that an actuator 98 of the extraction tool 70 may be operably coupled to the output feature 88 of the extraction tool 70, as described further herein.

Referring still to FIGS. 23-26, the extraction tool 70 includes the output feature 88. The output feature 88 is disposed within the output feature housing region 86 of the housing 78. The output feature 88 may be an assembly of a plurality of components, in some embodiments. For example, as illustrated in FIG. 24, the output feature 88 includes a first component 100 and a second component 102 fixed to the first component 100 and positioned nearer than the first component 100 to the mouth 90 of the housing 78. In various implementations, the output feature 88 may be operably coupled to the actuator 98 via the first component 100, and the plurality of engagement fingers 68 may be movably coupled to the second component 102 of the output feature 88, as described further herein.

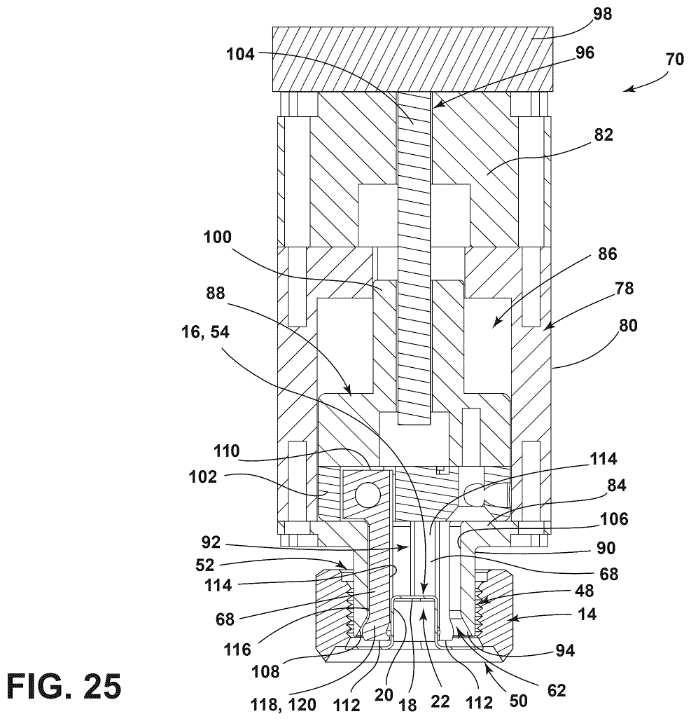

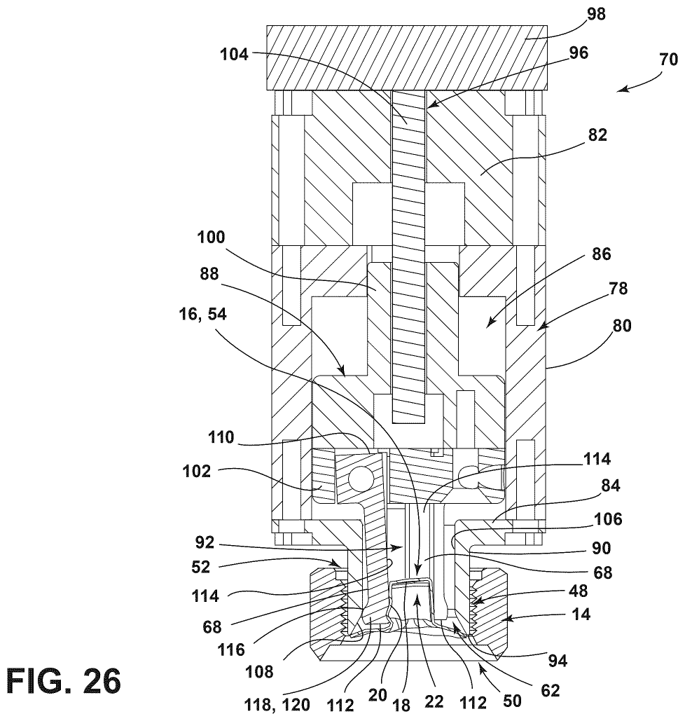

The output feature 88 is operable to move between a first position and a second position within the output feature housing region 86. In various implementations, the output feature 88 is configured to move between the first position and the second position within the output feature housing region 86 responsive to actuation of the actuator 98 of the extraction tool 70 that is operably coupled to the output feature 88. In some implementations, the output feature 88 is operable to translate away from the mouth 90 of the housing 78 from the first position to the second position within the output feature housing region 86. For example, as illustrated exemplarily and FIGS. 25 and 26, the output feature 88 translates away from the mouth 90 of the housing 78 from the first position (FIG. 25) to the second position (FIG. 26) responsive to actuation of the actuator 98 that is operably coupled to the first component 100 of the output feature 88.

In the embodiment illustrated in FIGS. 25 and 26, the actuator 98 is operably coupled with the output feature 88 via an elongated member 104 that extends through the passage 96 defined by the first end portion 82 of the housing 78 and into a receiving hollow defined by the first component 100 of the output feature 88. In the exemplary embodiment, the actuator 98 is a linear actuator 98 that is configured to translate the elongated member 104 and, thereby, translate the output feature 88 coupled to the elongated member 104 from the first position to the second position. It is contemplated that the extraction tool 70 may include a variety of types of actuators 98, in various implementations. For example, in some implementations, the actuator 98 may include an electric motor, the elongated member 104 may be threaded, and the output feature 88 may be correspondingly threaded and engaged with the threaded elongated member 104, such that the electric motor, threaded elongated member 104, and output feature 88 act as a spindle drive. In such an embodiment, the elongated member 104 may act as the driving element, and the output feature 88 may act as the driven nut that translates between the first and second positions responsive to rotation of the threaded elongated member 104 by the electric motor of the actuator 98.

Referring now to FIGS. 24-26, the extraction tool 70 includes the plurality of engagement fingers 68 that are operably coupled with the output feature 88. As illustrated in FIGS. 24-26, the engagement fingers 68 extend within the mouth hollow 92 of the housing 78. In an exemplary embodiment, the extraction tool 70 includes three engagement fingers 68 that are spaced apart from each other equidistantly in the circumferential direction. In various implementations, the plurality of engagement fingers 68 are operably coupled with the output feature 88, such that the plurality of engagement for fingers are operable to move relative to the output feature 88 from disengaged positions to engaged positions. In various embodiments, movement of the output feature 88 from the first position to the second position prompts movement of the plurality of engagement fingers 68 relative to the output feature 88 from the disengaged positions to the engaged positions.

In the exemplary embodiment illustrated in FIGS. 25 and 26, the plurality of engagement fingers 68 are pivotably coupled with the output feature 88, and translation of the output feature 88 from the first position to the second position prompts pivotal movement of the plurality of engagement fingers 68 relative to the output feature 88 from the disengaged positions to the engaged positions. As illustrated in FIGS. 25 and 26, the mouth 90 of the housing 78 of the extraction tool 70 includes an interior surface 106 that defines the mouth hollow 92. The interior surface 106 of the mouth 90 includes a tapered portion 108 that extends radially inboard as the tapered portion 108 extends axially toward the output feature 88 of the extraction tool 70. In various implementations, movement of the plurality of engagement fingers 68 with the output feature 88, as the output feature 88 translates from the first position to the second position, causes the engagement fingers 68 to interfere with the tapered portion 108 of the interior surface 106 of the mouth 90. This interference prompts pivotal movement of the plurality of engagement fingers 68 relative to the output feature 88 to the engaged positions, as illustrated in FIG. 26.

Referring now to FIGS. 24-26, each of the plurality of engagement fingers 68 extends from a first end 110 to a second end 112. In various implementations, the first end 110 of the engagement finger 68 is positioned further than the second end 112 of the engagement finger 68 from the mouth 90 of the housing 78. In various embodiments, the engagement finger 68 is pivotably coupled to the output feature 88 proximate to the first end 110 of the engagement feature, and the second end 112 of the engagement finger 68 is configured to impinge on the side wall 20 of the cap 16 to plastically deform the side wall 20 of the cap 16 radially inboard in the engaged position of the engagement finger.

Each of the plurality of engagement fingers 68 further includes a radially inboard surface 114 and a radially outboard surface 116 opposite the radially inboard surface 114. In various implementations, the radially inboard surface 114 of each of the plurality of engagement fingers 68 is configured to impinge on the side wall 20 of the cap 16 in the engaged position of the engagement finger, as illustrated in FIG. 26. In some embodiments, the radially outboard surface 116 of the engagement finger 68 includes a protruding portion 118 that extends radially outboard proximate to the second end 112 of the engagement finger. For example, as illustrated in FIGS. 24-26, the radially outboard surface 116 of the engagement finger 68 includes the protruding portion 118 in the form of a protuberance 120 that extends radially outboard proximate the second end 112 of the engagement finger.

In various implementations, the protruding portion 118 of the radially outboard surface 116 of the engagement finger 68 is configured to interfere with the tapered portion 108 of the interior surface 106 of the mouth 90 of the housing 78 due to movement of the engagement finger 68 with the output feature 88 as the output feature 88 translates from the first position to the second position. For example, as illustrated in FIG. 26, the protuberance 120 that extends radially outboard proximate to the second end 112 of the engagement finger 68 contacts the tapered portion 108 of the interior surface 106 of the mouth 90, and the contact between the tapered portion 108 and the protuberance 120 prompts the engagement finger 68 to pivot to the engaged position as the output feature 88 translates from the first position to the second position.

In various implementations, the extraction tool 70 is configured to extract the cap 16 from the pass-through hollow 48 of the spud 14 through the outer opening 52 of the spud 14. In operation of an exemplary embodiment of the extraction tool 70, a user first aligns the extraction tool 70 with the spud 14 and the cap 16 disposed therein, as illustrated in FIG. 25. In the aligned position of the extraction tool 70, the mouth 90 of the housing 78 of the extraction tool 70 extends into the pass-through hollow 48 of the spud 14 through the outer opening 52. The engagement fingers 68, which are disposed in the disengaged positions, likewise, extend within the pass-through hollow 48 of the spud 14 along the side wall 20 of the cap 16 that is inserted into the pass-through hollow 48.

Next, the actuator 98 actuates, which translates the output feature 88 away from the spud 14 from the first position to the second position within the output feature housing region 86. This translation of the output feature 88 prompts corresponding movement of the plurality of engagement fingers 68. As the engagement fingers 68 move with the output feature 88 from the first position to the second position, the protruding portions 118 of each of the engagement fingers 68 come into dynamic contact with the tapered portion 108 of the interior surface 106 of the mouth 90 of the housing 78. This dynamic contact between the engagement fingers 68 and the tapered portion 108 of the mouth 90 causes the engagement fingers 68 to pivot from the disengaged positions to the engaged positions as the output feature 88 translates from the first position to the second position.

Pivotal movement of the engagement fingers 68 from the disengaged positions to the engaged positions causes the engagement fingers 68 to impinge on the side wall 20 of the cap 16 to plastically deform the side wall 20 radially inboard, as illustrated in FIG. 26. This radially-inboard deformation of the side wall 20 of the cap 16 prompts corresponding deformation of the flange 62 of the cap 16, which is influenced and/or controlled by the strategically positioned grooves 72 that extend along the flange 62, such that the resulting plastically-deformed cap 16 is sized to be extracted from the pass-through hollow 48 through the outer opening 52. Finally, the cap 16 is extracted from the pass-through hollow 48 through the outer opening 52 by withdrawing the mouth 90, engagement fingers 68, and cap 16 from the pass-through hollow 48 of the spud 14.

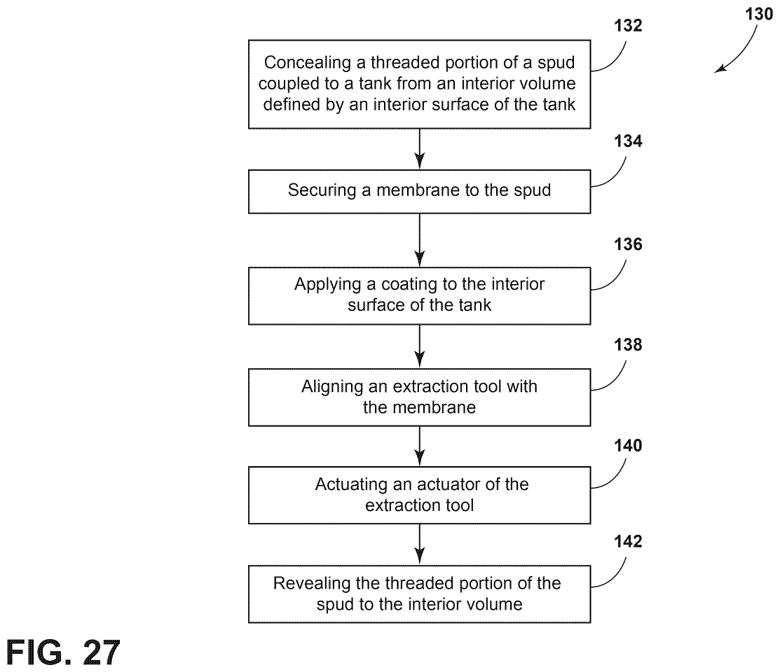

Referring now to FIG. 27, a method 130 of manufacturing a tank 12 for holding hot water can include a step 132 of concealing the threaded portion 28 of the spud 14 coupled to the tank 12 from the interior volume 44 defined by the interior surface 40 of the tank 12. In some implementations, the threaded portion 28 of the spud 14 is concealed from the interior volume 44 defined by the interior surface 40 of the tank 12 at step 132 with the membrane 54 by arranging the membrane 54 relative to the pass-through hollow 48 that is defined by the spud 14. In some embodiments, the membrane 54 forms the cap 16. In such implementations, the step 132 can comprise concealing the threaded portion 28 of the spud 14 coupled to the tank 12 from the interior volume 44 defined by the interior surface 40 of the tank 12 with the cap 16 by inserting the cap 16 into the pass-through hollow 48 that is defined by the spud 14. In some implementations, the cap 16 is inserted into the pass-through hollow 48 through the inner opening 50 toward the outer opening 52 at step 132. For example, in the embodiments illustrated in FIGS. 10, 11, 15, 16, 20, and 21, the cap 16 is inserted into the pass-through hollow 48 through the inner opening 50 toward the outer opening 52. In some embodiments, the cap 16 is inserted into the pass-through hollow 48 through the outer opening 52 toward the inner opening 50. For example, in the embodiments illustrated in FIGS. 4-9, the cap 16 is inserted into the pass-through hollow 48 through the outer opening 52 toward the inner opening 50.

In some implementations, the cap 16 elastically deforms during insertion of the cap 16 into the pass-through hollow 48 due to contact with the spud 14 at step 132. For example, in an exemplary embodiment illustrated in FIGS. 4-7, the cap 16 includes the base 18, the side wall 20, and the annular skirt 24 that is coupled to the side wall 20 and that includes the peripheral rim 26 that is distal from the side wall 20. At step 132, the threaded portion 28 of the spud 14 is concealed from the interior volume 44 defined by the interior surface 40 of the tank 12 with the cap 16 by inserting the cap 16 into the outer opening 52 of the pass-through hollow 48. As the cap 16 is inserted, the annular skirt 24 elastically deforms from the first position, wherein the peripheral rim 26 is a first distance from the side wall 20, to a second position, wherein the annular skirt 24 is in contact with the threaded portion 28 of the spud 14 and the peripheral rim 26 is a second distance from the side wall 20. As insertion of the cap 16 into the pass-through hollow 48 progresses, the annular skirt 24 resiliently rebounds back from the second position to a third position, wherein the peripheral rim 26 is positioned within the annular channel 30 of the spud 14 and the peripheral rim 26 is a third distance from the side wall 20. The first and third distances are greater than the second distance. The first distance can be greater than the third distance. In some embodiments, the first distance is equal to the third distance.

The method 130 of manufacturing the tank 12 for holding hot water can include a step 134 of securing the membrane 54 to the spud 14. In some implementations, the step 134 of securing the membrane 54 to the spud 14 comprises welding the membrane 54 to the spud 14. For example, in an embodiment wherein the membrane 54 forms the cap 16, the step 134 may comprise welding the cap 16 to the spud 14. In the exemplary embodiment illustrated in FIG. 9, the flange 62 of the cap 16 is welded to an end 122 of the spud 14 proximate the outer opening 52 of the pass-through hollow 48. In some implementations, the step 134 of securing the membrane 54 to the spud 14 comprises securing the membrane 54 to the spud 14 via a plurality of tabs 76 of the spud 14 that extend along the membrane 54. For example, as illustrated in FIGS. 16 and 21, the spud 14 includes a plurality of tabs 76 that extend along the second side 66 of the flange 62 of the cap 16 proximate to the peripheral rim 26. In some embodiments, the tabs 76 are machined into the spud 14 after the cap 16 is inserted into the pass-through hollow 48 of the spud 14 to extend along the flange 62 and secure the cap 16 relative to the spud 14.

Referring still to FIG. 12, the method 130 can include a step 136 of applying the coating 46 to the interior surface 40 of the tank 12. In some implementations, applying the coating 46 to the interior surface 40 of the tank 12 includes spraying unfired glass on the interior surface 40 of the tank 12. It is contemplated that a variety of types of coatings 46 may be applied to the interior surface 40 of the tank 12. For example, the step 136 of applying the coating 46 may comprise application of a coating 46 of porcelain, ceramic, polymer, organic material, electroplating, and/or other materials suitable to prevent the interior surface 40 of the tank 12 from rusting.

Referring still to FIG. 12, the method 130 can include a step 138 of aligning the extraction tool 70 with the membrane 54. In various implementations, wherein the membrane 54 forms the cap 16, the step 138 comprises aligning the extraction tool 70 with the cap 16. In some embodiments, the step 138 of aligning the extraction tool 70 includes positioning the cap 16 and the extraction tool 70 relative to each other such that the engagement fingers 68 of the extraction tool 70 extend within the pass-through hollow 48 of the spud 14 and along the side wall 20 of the cap 16. As illustrated in FIG. 25, the step 138 of aligning the extraction tool 70 may include relatively positioning the extraction tool 70 and the spud 14, such that the mouth 90 of the housing 78 of the extraction tool 70 extends into the pass-through hollow 48 defined by the spud 14 within which the cap 16 is inserted.

Referring still to FIG. 12, the method 130 can include the step 140 of actuating the actuator 98 of the extraction tool 70. Actuation of the actuator 98 at step 140 may result in movement, such as translation, of the output feature 88 of the extraction tool 70 from the first position to the second position within the output feature housing region 86 of the housing 78, corresponding movement of the plurality of engagement fingers 68 with the output feature 88, and movement, such as pivotal movement, of the plurality of engagement fingers 68 relative to the output feature 88 from the disengaged positions to the engaged positions to impinge on the side wall 20 of the cap 16, as illustrated in FIG. 26. The impingement on the side wall 20 of the cap 16 may plastically deform the cap 16 to allow for removal of the cap 16 from the pass-through hollow 48 through the outer opening 52 of the spud 14, in various embodiments. In various implementations, wherein the flange 62 of the cap 16 includes the plurality of grooves 72, the step 140 of actuating the actuator 98 prompts impingement of the side wall 20 of the cap 16, which results in plastic deformation of the side wall 20 and the plastic deformation of the flange 62 at the grooves 72, such that the resulting plastically deformed cap 16 is sized to be removed from the pass-through opening out of the outer opening 52 of the spud 14.

Referring still to FIG. 12, the method 130 can include a step 142 of revealing the threaded portion 28 of the spud 14 to the interior volume 44 of the tank 12. In various embodiments, the threaded portion 28 of the spud 14 is revealed to the interior volume 44 at step 142 by plastically deforming the membrane 54. For example, the membrane 54 may be plastically deformed and extracted through the outer opening 52 of the pass-through hollow 48 of the spud 14 to reveal the threaded portion 28 of the spud 14 to the interior volume 44 at step 142. In some implementations, the membrane 54 is plastically deformed and extracted through the outer opening 52 of the pass-through hollow 48, such that the entirety of the membrane 54 is separated from the spud 14. In some embodiments, a portion of the membrane 54 may remain coupled with a portion of the spud 14 after the membrane 54 is plastically deformed and extracted. For example, in an embodiment wherein the membrane 54 is welded to the spud 14, the portion of the membrane 54 that is welded to the spud 14 may remain fixed to the spud 14 after plastic deformation and extraction of the membrane 54.

In some implementations of the method 130, wherein the membrane 54 forms the cap 16, the step 142 can include revealing the threaded portion 28 of the spud 14 to the interior volume 44 by plastically deforming the cap 16 to remove the cap 16 from the pass-through hollow 48 through the outer opening 52. In an exemplary implementation, the step 142 includes revealing the threaded portion 28 of the spud 14 to the interior volume 44 by plastically deforming the cap 16 to remove the cap 16 from the pass-through hollow 48 through the outer opening 52, as described above herein, via actuation of the actuator 98 of the extraction tool 70 at step 140. In some embodiments, the cap 16 is plastically deformed and removed from the pass-through hollow 48 through the outer opening 52, such that the entirety of the cap 16 is separated from the spud 14. It is contemplated that the cap 16 may be removed through the outer opening 52 in a variety of manners. Further, it is contemplated that the threaded portion 28 may be revealed at step 142 via removal of the membrane 54 and/or cap 16 through the inner opening 50 of the pass-through hollow 48, in some implementations.

The cap 16, the extraction tool 70, and the method 130 of manufacturing the tank 12 of the water heater 10 of the present disclosure may provide a variety of advantages. First, the cap 16 having the elastically deformable annular skirt 24 and the spud 14 having the annular channel 30 may allow for convenient, snap-in insertion of the cap 16 to conceal the threaded portion 28 of the spud 14 to protect the threaded portion 28 while the coating 46 is applied to the interior surface 40 of the tank 12. Second, the side wall 20 of the cap 16 having the shoulder portion 56 that forms a friction-fit with the spud 14 allows the cap 16 to conceal the threaded portion 28 of the spud 14 without welding the cap 16 to the spud 14, which simplifies insertion of the cap 16 and allows for more convenient removal of the cap 16 from the spud 14 after the coating 46 is applied to the interior surface 40 of the tank 12. Third, removing the membrane 54 and/or cap 16 through the outer opening 52 of the pass-through hollow 48 ensures that the membrane 54 and/or cap 16 is not undesirably deposited within the tank 12 of the water heater 10 after removal. Fourth, the flange 62 of the spud 14 including the plurality of grooves 72 allows for relatively controlled plastic deformation of the flange 62 of the cap 16 that results in a plastically-deformed cap 16 that has a small enough footprint to fit through the pass-through hollow 48 for extraction of the cap 16 through the outer opening 52 of the spud 14. Fifth, the extraction tool 70 provides a system for consistently applying a uniform impinging force on the side wall 20 the cap 16 disposed within the spud 14 that results in plastic deformation of the cap 16 suitable to allow for extraction of the cap 16 from the pass-through hollow 48 of the spud 14 through the outer opening 52 of the spud 14.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A cap for insertion into a spud of a water heater, comprising:
a base;
a side wall extending from the base to define a cavity together with the base; and
a flange coupled to the side wall and extending outward therefrom to a peripheral rim, the flange having a first side and a second side that is opposite the first side and further than the first side from the base, wherein at least one of the first side of the flange and the second side of the flange includes a plurality of grooves.

2. The cap of claim 1, wherein the plurality of grooves extend outward along the flange in radial fashion.

3. The cap of claim 2, wherein the second side of the flange includes the plurality of grooves.

4. The cap of claim 3, wherein the second side of the flange includes an annular groove that is positioned radially between the peripheral rim and the side wall of the flange and intersects the plurality of grooves extending outward along the second side of the flange in radial fashion.

5. The cap of claim 2, wherein the first side of the flange includes the plurality of grooves.

6. The cap of claim 2, wherein the first and second sides of the flange include the plurality of grooves.

7. The cap of claim 6, wherein the plurality of grooves are arranged such that, for a given groove extending outward along one of the first side and the second side of the flange in radial fashion, a pair of grooves that are circumferentially adjacent to the given groove extend outward along the other of the first side and the second side of the flange in radial fashion.

8. The cap of claim 2, wherein the plurality of grooves extend to the peripheral rim of the flange.

9. The cap of claim 1, wherein an outer diameter of the side wall is about a third of a diameter of the peripheral rim of the flange.

10. An extraction tool for extracting a cap from a spud of a water heater, comprising:
a housing that defines an output feature housing region and includes a mouth that defines a mouth hollow in communication with the output feature housing region and a mouth opening distal from the output feature housing region;
an output feature disposed within the output feature housing region of the housing and operable to move between a first position and a second position within the output feature housing region responsive to actuation of an actuator operably coupled thereto; and
a plurality of engagement fingers operably coupled with the output feature and extending within the mouth hollow, wherein movement of the output feature from the first position to the second position prompts movement of the plurality of engagement fingers relative to the output feature from disengaged positions, wherein the plurality of engagement fingers are configured to extend within a pass-through hollow of the spud and along a side wall of the cap, to engaged positions, wherein the plurality of engagement fingers are configured to impinge on the side wall of the cap to plastically deform the side wall radially-inboard.

11. The extraction tool of claim 10, wherein the output feature is operable to translate away from the mouth of the housing from the first position to the second position within the output feature housing region.

12. The extraction tool of claim 11, wherein the plurality of engagement fingers are pivotably coupled with the output feature, and translation of the output feature from the first position to the second position prompts pivotal movement of the plurality of engagement fingers relative to the output feature from the disengaged positions to the engaged positions.

13. The extraction tool of claim 12, wherein the mouth includes an interior surface that defines the mouth hollow, and the interior surface of the mouth includes a tapered portion that extends radially inboard as the tapered portion extends axially toward the output feature, and wherein movement of the plurality of engagement fingers with the output feature as the output feature translates from the first position to the second position causes the engagement fingers to interfere with the tapered portion which prompts pivotal movement of the plurality of engagement fingers to the engaged positions.

14. The extraction tool of claim 13, wherein each of the plurality of engagement fingers extends from a first end to a second end and includes a radially inboard surface that is configured to impinge on the side wall of the cap in the engaged position and a radially outboard surface opposite the radially inboard surface, wherein the radially outboard surface includes a protruding portion that extends radially outboard proximate to the second end of the engagement finger, and the protruding portion interferes with the tapered portion due to movement of the engagement finger with the output feature as the output feature translates from the first position to the second position.

15. A method of manufacturing a tank for holding hot water, comprising the steps of:
concealing a threaded portion of a spud coupled to the tank from an interior volume defined by an interior surface of the tank with a cap by inserting the cap into a pass-through hollow that is defined by the spud and that extends from an outer opening that is distal from the tank to an inner opening that is proximal to the tank;
applying a coating to the interior surface of the tank; and
revealing the threaded portion of the spud to the interior volume by plastically deforming the cap to remove the cap from the pass-through hollow through the outer opening.

16. The method of claim 15, further comprising the steps of:
aligning an extraction tool with the cap, such that a plurality of engagement fingers of the extraction tool extend within the pass-through hollow of the spud and along a side wall of the cap; and
actuating an actuator of the extraction tool, such that the plurality of engagement fingers move from disengaged positions to engaged positions to impinge on the side wall of the cap, wherein the impingement on the side wall of the cap plastically deforms the cap to allow removal of the cap from the pass-through hollow through the outer opening.

17. The method of claim 15, further comprising the step of securing the cap to the spud via a plurality of tabs of the spud that extend along a flange of the cap.

18. The method of claim 15, wherein the cap is inserted into the pass-through hollow through the inner opening toward the outer opening.

19. The method of claim 15, wherein the cap is plastically deformed and removed from the pass-through hollow through the outer opening, such that the entirety of the cap is separated from the spud.

20. The method of claim 15, wherein the cap comprises:
a base;
a side wall extending from the base to define a cavity together with the base; and
a flange coupled to the side wall and extending outward therefrom to a peripheral rim, the flange having a first side and a second side that is opposite the first side and further than the first side from the base, wherein at least one of the first side of the flange and the second side of the flange includes a plurality of grooves.
